(19) United States
(12) Patent Application Publication
(10) Pub. No.: US 2026/0274022 A1
(43) Pub. Date: Sep. 17, 2026

(54) VEHICLE SUSPENSION ARRANGEMENT AND ELECTRIC VEHICLE

(71) Applicant: 18 WHEELS OY, Lahti (FI)

(72) Inventor: Eldar ALIEV, Lahti (FI)

(21) Appl. No.: 19/167,761

(22) PCT Filed: Mar. 21, 2024
(86) PCT No.: PCT/FI2024/050135

§ 371 Date: Sep. 22, 2025

(30) Foreign Application Priority Data
Mar. 22, 2023 (FI) 20235333

(51) Int. Cl. B60G 3/00; B60G 15/00; B60K 1/02; B60K 7/00; B62D 61/00

(52) U.S. Cl. CPC B60G 3/00; B60G 15/00; B60K 1/02; B60K 7/0007; B62D 61/00; B60G 2200/10; B60G 2202/30

(57) ABSTRACT

A vehicle suspension arrangement includes at least three wheels and each of the at least three wheels are independently supported to a chassis of a vehicle with a separate suspension support. The suspension is configured to define a wheel suspension trajectory along which the wheel is arranged to move in the suspended manner in relation to the chassis. The wheel suspension trajectory is configured to extend transversely to the vertical direction in a basic support position of the vehicle in which the vehicle is supported on a surface extending perpendicularly to the vertical direction.

### FIELD OF THE INVENTION

The present invention relates to a vehicle suspension arrangement and more particularly to a vehicle suspension arrangement according to preamble of claim 1. The present invention further relates to an electric vehicle and more particularly to an electric vehicle according to preamble of claim 14.

### BACKGROUND OF THE INVENTION

In the prior art vehicles, the maximal height of an obstacle that the vehicle is able to run over, is limited by the diameter of the wheel. A non-driving wheel is usually able to run over an obstacle having height of 0.3 times the diameter of the wheel. On the other hand, driving wheel is usually able to run over an obstacle having height of 0.5 times the diameter of the wheel. For this reason, the wheels of modern vehicles must be relatively large in diameter.

Moreover, a high obstacle can cause a shock impulse to the wheel and to the chassis of the vehicle via a suspension of the wheel. In order to avoid the shock impulse, the vehicle should run over the obstacle at low speed.

The large diameter of the wheels results in increase in the unsuspended mass. The unsuspended mass is one of the main characteristics of vehicles. It strongly affects the ride quality at speeds higher than 30 km/h.

The large diameter of the wheels further results in increase in the required wheel drive torque. This makes unavoidable the application of reduction gears, which in turn, complicates the design of the transmission. In the case of electric motors incorporated in the wheels, the required torque for the large wheel results in a large mass of the motor and, therefore, increases the unsuspended mass. Electric motors incorporated in wheels are the most efficient solution for electric vehicles, since they enable to exclude the transmission. The use of transmission makes a vehicle heavier, more complex and more expensive. Moreover, the transmission reduces the overall efficiency of the system. However, the use of motors incorporated in wheels dramatically increases the unsuspended mass.

### BRIEF DESCRIPTION OF THE INVENTION

An object of the present invention is to provide a vehicle suspension arrangement and an electric vehicle so as to solve or at least alleviate prior art disadvantages.

The objects of the invention are achieved by a vehicle suspension arrangement which is characterized by what is stated in the independent claim 1. The objects of the invention are further achieved by an electric vehicle which is characterized by what is stated in the independent claim 14.

The preferred embodiments of the invention are disclosed in the dependent claims.

The invention is based on the idea of a vehicle suspension arrangement. The vehicle suspension arrangement comprises at least three wheels and each of the at least three wheels is independently supported to a chassis of a vehicle with a separate suspension support. The suspension support comprises a strut connected between the wheel and the chassis of the vehicle for supporting the wheel in a suspended manner to the chassis, and the suspension support being configured to define a wheel suspension trajectory along which the wheel is arranged to move in the suspended manner in relation to the chassis. The wheel suspension trajectory defined by the suspension support is configured to extend transversely to the vertical direction in a basic support position of the vehicle in which the vehicle is supported on a surface extending perpendicularly to the vertical direction. The vehicle suspension arrangement comprises at least three wheels arranged successively in a line and the at least three wheels are provided with electric motors. The wheel suspension trajectory defined by the suspension support is configured to have a trajectory angle between 15 to 80 degrees in relation to the vertical direction in the basic support position of the vehicle in which the vehicle is supported on the surface extending perpendicularly to the vertical direction.

When a vehicle having the suspension arrangement encounters an obstacle, each wheels moves independently in the suspended manner to overrun the obstacle. Further, wheel suspension trajectory which is transverse to the vertical direction has a vertical trajectory component and a horizontal trajectory component. The horizontal trajectory component alleviates overrunning large obstacles due to the wheel suspension trajectory which is inclined in relation to the vertical direction.

The wheel suspension trajectory defined by the suspension support is configured to have a trajectory angle between 15 to 80 degrees in relation to the vertical direction in the basic support position of the vehicle in which the vehicle is support on the surface extending perpendicularly to the vertical direction. This trajectory angle range provides suspension in both vertical and horizontal directions and alleviates overrunning high obstacles.

In some embodiments, the trajectory angle is between 20 to 70 degrees in relation to the vertical direction. This trajectory angle range provides enhanced suspension in both vertical and horizontal directions and alleviates overrunning high obstacles without compromising vertical or horizontal suspension unnecessarily.

In some further embodiments, the trajectory angle between 25 to 60 degrees in relation to the vertical direction. This trajectory angle range provides further enhanced suspension in both vertical and horizontal directions and alleviates overrunning high obstacles without compromising vertical or horizontal suspension unnecessarily.

The trajectory angle defines the inclination of the wheel suspension trajectory along which the wheel moves during suspension movement in relation to the chassis of the vehicle. The trajectory angle defines the vertical and horizontal components of the wheel suspension trajectory. The trajectory angle is configured to provide adequate vertical support for the vehicle and good horizontal component for the wheel suspension trajectory.

In some embodiments, the suspension support is configured to define a linear wheel suspension trajectory or a curved suspension trajectory.

The linear wheel suspension trajectory is provided by utilizing a rigid and fixed strut in the vehicle suspension arrangement.

The curved wheel suspension trajectory is provided by utilizing a flexible strut in the vehicle suspension arrangement. Alternatively, the curved wheel suspension trajectory is provided by a strut which is pivotably connected to the chassis.

In the present application the direction of the wheel suspension trajectory is defined between end points of the wheel suspension trajectory. Therefore, the direction of the wheel suspension trajectory is linear. The direction of the wheel suspension trajectory is linear when the wheel suspension movement is linear and curved.

In the present application the trajectory angle is defined as the angle between the direction of the wheel suspension trajectory and vertical direction. The vertical direction is the direction of gravity.

In some embodiments, the suspension support is provided with one or more spring elements configured to enable suspension movement of the wheel in relation to the chassis in the suspended manner along the wheel suspension trajectory.

The one or more spring elements are configured to provide spring force and spring displacement. The spring displacement of the one or more spring elements is configured to enable the suspension movement of the wheel in relation to the chassis in a direction along the wheel suspension trajectory.

In some embodiments, the strut is provided with the one or more spring elements, the strut and the one or more spring elements are configured to define the wheel suspension trajectory together and to enable the suspension movement of the wheel in relation to the chassis in the suspended manner along the wheel suspension trajectory.

Providing the strut with the one or more spring elements enables arranging the wheel suspension trajectory to extend along the strut. This provides mechanically simple and durable suspension support.

In some embodiments, the strut is arranged to extend in a strut direction from the chassis transversely to the vertical direction in the basic support position of the vehicle, the wheel suspension trajectory is arranged extend in the strut direction and the one or more spring element are configured to enable the suspension movement of the wheel in the strut direction.

Accordingly, the suspension movement of the wheel in the wheel suspension trajectory is arranged in the direction of the strut. The strut extends in the direction of the wheel suspension trajectory. Thus, the strut is arranged to define the direction of the wheel suspension trajectory. The wheel suspension trajectory is linear.

In some other embodiments, the strut is arranged to extend in a strut direction from the chassis in a strut angle in relation to the vertical direction in the basic support position of the vehicle, the one or more spring elements are configured to enable the suspension movement of the wheel in the strut direction, the trajectory angle of the wheel suspension trajectory corresponding the strut angle.

Accordingly, the suspension movement of the wheel in the wheel suspension trajectory is arranged in the direction of the strut. The strut angle is arranged to define the trajectory angle of the wheel suspension trajectory.

In some embodiments, the one or more spring elements are arranged between the strut and the chassis of the vehicle, the strut and the one or more spring elements are configured to define the wheel suspension trajectory together and to enable the suspension movement of the wheel in relation to the chassis in the suspended manner along the wheel suspension trajectory.

Providing the one or more spring elements between the chassis and the strut enables strut to be arranged movable in relation to the chassis. The one or more spring elements are configured to provide the strut movable in relation to the chassis. This further enables the suspension movement to be defined by movement of the strut in relation to the chassis. Accordingly, the strut, the one or more spring elements and the movement of the strut are configured to define the wheel suspension trajectory together and to enable the suspension movement of the wheel in relation to the chassis in the suspended manner along the wheel suspension trajectory.

In some embodiments, the strut is pivotably connected to the chassis and arranged to extend from the chassis, the strut is arranged to move with a pivotable strut movement in relation to the chassis, the strut and the pivotable strut movement are configured to define the wheel suspension trajectory, the one or more spring elements are configured to apply spring force to strut during the pivotable strut movement of the strut, the one or more spring elements are configured to enable the suspension movement of the wheel along the wheel suspension trajectory upon the pivotable strut movement of the strut.

In some other embodiments, the strut is pivotably connected to the chassis and arranged to extend from the chassis, the strut is arranged to move with a pivotable strut movement around a horizonal strut pivot axis in relation to the chassis, the strut and the pivotable strut movement are configured to define the wheel suspension trajectory, the one or more spring elements are configured to apply spring force to strut during the pivotable strut movement of the strut, the one or more spring elements are configured to enable the suspension movement of the wheel along the wheel suspension trajectory upon the pivotable strut movement of the strut around the horizontal strut pivot axis.

In some embodiments, the strut is provided as a flexible strut, the flexible strut is configured to form the one or more spring elements and to bend in a strut bending direction transverse to the vertical direction in the basic support position of the vehicle, the flexible strut and the strut bending direction are configured to define the wheel suspension trajectory and to enable the suspension movement of the wheel in relation to the chassis in the suspended manner along the wheel suspension trajectory.

In some embodiments, the flexible strut is provided as a longitudinal arch-shaped strut and arranged to extend from the chassis of the vehicle.

In some other embodiments, the flexible strut is provided as a longitudinal linear strut and arranged to extend from the chassis of the vehicle.

In some embodiments the suspension arrangement comprises a strut adjustment mechanism arranged to adjust the strut direction of the strut, in which strut direction the strut is arranged to extend from the chassis transversely to the vertical direction in the basic support position of the vehicle.

In some other embodiments, the suspension support further comprises an additional suspension element arranged between the one or more spring elements and the chassis.

In some embodiments, the vehicle suspension arrangement comprises at least three wheels arranged successively in a line.

In some other embodiments, the vehicle suspension arrangement comprises at least three wheels arranged successively in a first line and at least three wheels arranged successively in a second line, the first line and the second line being arranged adjacent to each other.

Arranging at least three wheels successively means that the wheels are arranged one after the other in a moving direction of the vehicle. Accordingly, the at least three wheels are arranged successively in direction between a front end and back end of the vehicle of the chassis of the vehicle. The at least three wheels are arranged successively in moving direction of the vehicle.

Further, arranging at least three wheels successively means that the wheels are arranged successively in a direction transversal to rotation axis of the wheels.

In some embodiments, the at least three wheels are arranged successively in line.

The above mentioned different embodiments of the suspension arrangement may be combined in any technically feasible manner.

The present invention is also based on an idea of providing an electric vehicle. The electric vehicle comprises a chassis and a suspension arrangement. The suspension arrangement comprises at least three wheels, and a separate suspension support for each of the at least three wheels. Each of the wheels being independently supported to the chassis of the electric vehicle with the suspension support in a suspended manner. The suspension support being configured to define a wheel suspension trajectory along which the wheel is arranged to move in the suspended manner in relation to the chassis. The electric vehicle further comprises an electric motor operatively connected to at least one of the three wheels. The wheel suspension trajectory defined by suspension support is configured to extend transversely to the vertical direction in a basic support position of the vehicle in which the vehicle is supported on a surface extending perpendicularly to the vertical direction. The suspension arrangement comprises at least three wheels arranged successively in a line. A separate electric motor operatively connected to each of the at least three wheels for providing driving power. The wheel suspension trajectory defined by the suspension support is configured to have a trajectory angle between 15 to 80 degrees in relation to the vertical direction in the basic support position of the vehicle in which the vehicle is support on the surface extending perpendicularly to the vertical direction.

In some embodiments, the wheel suspension trajectory defined by the suspension support is configured to have a trajectory angle in relation to the vertical direction in the basic support position of the vehicle, the trajectory angle being between 20 to 70 degrees and preferably 25 to 60 degrees in relation to the vertical direction.

In some embodiments, the suspension support is arranged to define the wheel suspension trajectory such that wheel suspension trajectory is configured to be inclined in relation to the vertical direction according to the trajectory angle in a direction opposite to the moving direction of the electric vehicle.

Accordingly, when the electric vehicle moves the wheel suspension trajectory is inclined in opposite direction in relation to the movement direction. Thus, during movement of the electric vehicle the wheel moves in opposite direction with the suspension movement along the wheel suspension trajectory. This further means that when the vehicle moves on a horizontal surface in a horizontal vehicle movement direction the horizontal component of the wheel suspension trajectory extends in opposite direction in relation to the horizontal vehicle movement direction.

In some other embodiments, the electric vehicle comprises a front end and a back end, the suspension support is arranged to define the wheel suspension trajectory such that wheel suspension trajectory is configured to be inclined in relation to the vertical direction according to the trajectory angle in a direction towards the back end of the electric vehicle.

Accordingly, when the wheel moves with the suspension movement in relation to the chassis along the wheel suspension trajectory, the wheel moves towards the chassis in vertical direction and towards the back end of the electric vehicle. Accordingly, when the electric vehicle moves forward the wheel suspension trajectory is inclined in opposite direction. Thus, during forward movement of the electric vehicle the wheel moves backwards with the suspension movement along the wheels suspension trajectory.

In some further embodiments, the electric vehicle comprises a front end and a back end, the suspension support is arranged to define the wheel suspension trajectory such that wheel suspension trajectory is configured to be inclined in relation to the vertical direction according to the trajectory angle in a direction towards the back end of the electric vehicle upon forward movement of the electric vehicle, and the suspension support is arranged to define the wheel suspension trajectory such that wheel suspension trajectory is configured to be inclined in relation to the vertical direction according to the trajectory angle in a direction towards the front end of the electric vehicle upon forward movement of the electric vehicle.

In some embodiments, the suspension arrangement comprises at least three wheels arranged successively in a line.

In some other embodiments, the suspension arrangement comprises at least three wheels arranged successively in a first line and at least three wheels arranged successively in a second line, the first line and the second line being arranged adjacent to each other.

In some embodiments, the electric vehicle comprise a separate electric motor operatively connected to at least two of the at least three wheels for providing driving power.

Three wheels provide enough support for a vehicle having the suspension arrangement of the present invention.

In some other embodiments, the electric vehicle comprise a separate electric motor operatively connected to each of the at least three wheels for providing driving power.

The electric motors connected wheels enable the wheels to overrun large objects together with the suspension arrangement of the present invention.

In some embodiments, the electric motors are provided to the at least three wheels.

In some embodiments, the suspension arrangement of the electric vehicle is a suspension arrangement according to any embodiment of the above described suspension arrangement.

The above mentioned different embodiments of the electric vehicle may be combined in any technically feasible manner.

An advantage of the invention is that the suspension arrangement of the present invention suspension allows the use of arbitrarily small wheels without reducing the vehicle's ability to overcome high obstacles. The small diameter of the wheels significantly reduces the unsuspended weight of the electric vehicle. The small diameter of the wheels further enable increasing efficiency of the electric motor when the lectic motor is incorporated in wheel. Due to the low unsuspended mass, the suspension arrangement of the present invention allows the vehicle to overcome large obstacles at a speed significantly higher than vehicles with known types of suspensions. Further, the suspension arrangement of the present invention causes a significantly lower pressure on the ground and distributes the pressure more evenly to the ground. Therefore, the suspension arrangement enables diminishing negative impacts to the ground surface on natural terrains.

### BRIEF DESCRIPTION OF THE DRAWINGS

The invention is described in detail by means of specific embodiments with reference to the enclosed drawings, in which

FIGS. 1 to 5 show schematically prior art vehicle suspension arrangements;

FIGS. 6 to 8 show schematically one embodiment according to the present invention;

FIGS. 9 to 11 show schematically another embodiment according to the present invention;

FIGS. 12 to 15 show schematically yet another embodiment according to the present invention;

FIGS. 16 to 19 show schematically a further embodiment according to the present invention;

FIGS. 20 to 23 show schematically different embodiments of an electric vehicle according to the present invention;

FIGS. 24 and 25 show schematically the operating principle of the present invention; and

FIG. 26 shows schematically one embodiment of a control system of an electric vehicle according to the present invention.

### DETAILED DESCRIPTION OF THE INVENTION

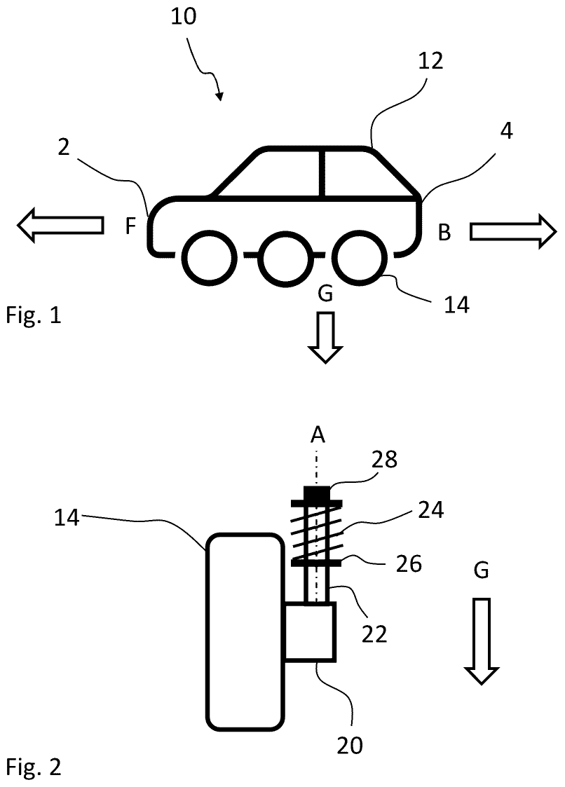

FIG. 1 shows schematically an electric vehicle 10. The electric vehicle in FIG. 1 is a car, however in the present invention the electric vehicle may be any kind of electric vehicle, such as car, motor cycle, scooter, or any other kind of electric vehicle or light electric vehicle.

The electric vehicle comprises a chassis 12 having a front end 2 and back end 4. The electric vehicle further has forward moving direction F. In the forward moving direction F the electric vehicle moves the front end ahead. The electric vehicle further has backward moving direction B. In the backward moving direction B the electric vehicle moves the back end ahead.

The electric vehicle 10 according to the present invention comprises at least three wheels 14.

The electric vehicle 10 further comprises at least one electric motor operatively connected to at least one of the wheels 14 and arranged to drive the at least one of the wheels 14.

In the present application vertical direction means the direction gravity G. Horizontal direction means a horizontal direction perpendicular to the vertical direction.

In the present application the electric vehicle 10 and suspension arrangement thereof is considered to be placed to a basic support position in which the electric vehicle 10 or the suspension arrangement thereof is supported on a surface extending perpendicularly to the vertical direction. Accordingly, in the basic support position the electric vehicle 10 and the suspension arrangement thereof is supported on a horizontal surface. Therefore, all the directions discussed in the present application relate to the basic support position of the electric vehicle and the suspension arrangement thereof.

FIG. 2 shows schematically one type of conventional suspension arrangement of a car. The suspension arrangement comprises wheel 14 and a strut 22. The wheel 14 is provided with a wheel connection element 20 and the strut 22 is connected to the wheel connection element 20 for connecting the strut 22 to the wheel 14. The strut 22 may be further connected to the chassis 12 of the vehicle 10.

The strut 22 is provided with a spring element 24 enabling suspension movement of the wheel 14 in relation to the chassis 12. The strut 22 is has a strut direction A extending in vertical direction G. The spring element 24 is provided with lower spring plate 26 and an upper spring plate 28. The spring element 24 is arranged between the lower spring plate 26 and the upper spring plate 28. The lower spring plate 26 and the upper spring plate 28 are arranged movable relative to each other in the strut direction A direction such that spring element 24 may compress and stretch upon the relative movement of the lower spring plate 26 and the upper spring plate 28. The upper spring plate 28 is connected to the chassis 12 of the vehicle 10 and the lower spring plate 26 is connected to the strut 22.

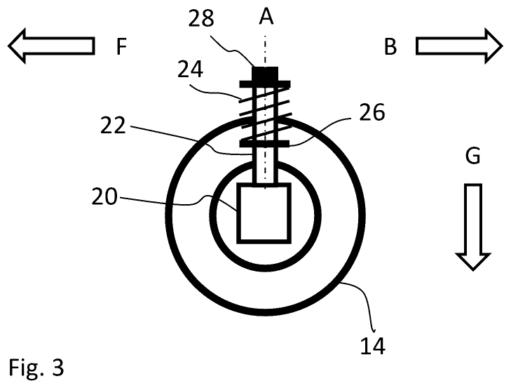

FIG. 3 shows side view of the prior art suspension arrangement of FIG. 2. The strut direction A is arranged to extend in the vertical direction G in the basic support position of the vehicle 10.

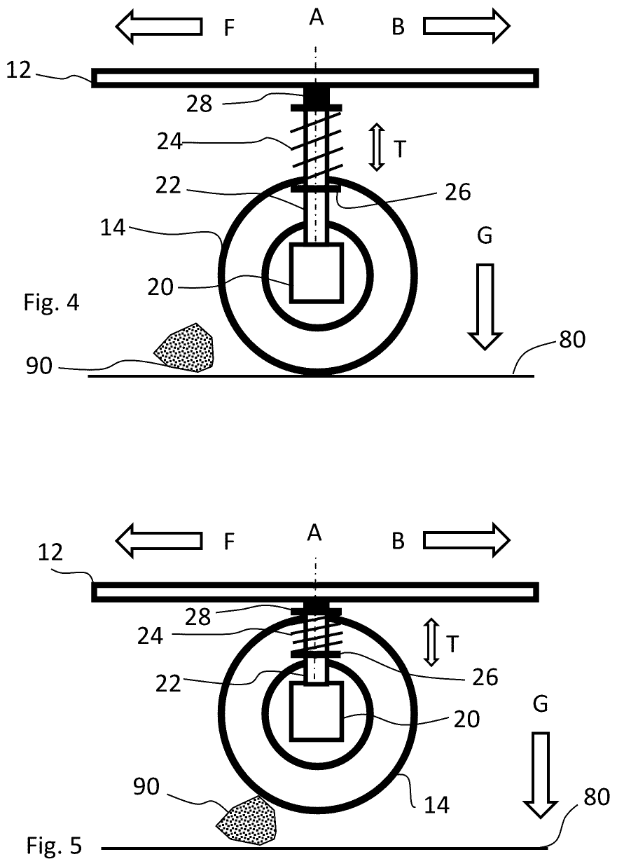

FIGS. 4 and 5 show schematically operation the prior art suspension arrangement of FIGS. 2 and 3 when the wheel 14 encounters an obstacle 90.

In FIG. 4 the suspension arrangement and the wheel 14 are shown in an initial suspension position on a flat horizontal surface 80. In the initial suspension position the wheel 14 is in an initial wheel position in relation to the chassis 12.

In FIG. 5 the suspension arrangement and the wheel 14 are shown in a final suspension position when the wheel 14 overrides a high obstacle 90. In the final suspension position the wheel 14 is in a final wheel position in relation to the chassis 12. In the final wheel position the spring element 24 is compressed and the wheel 14 is moved towards the chassis 12 along a wheel suspension trajectory in a suspension direction T. The wheel suspension trajectory extends between the wheel initial position and the wheel final position.

The strut 22 and the spring element 24 are arranged define the suspension direction T in which the wheel 14 moves along the wheel suspension trajectory. In the prior art suspension arrangement the suspension direction T of the wheel suspension trajectory extends in the vertical direction G, as shown in FIGS. 2 to 5.

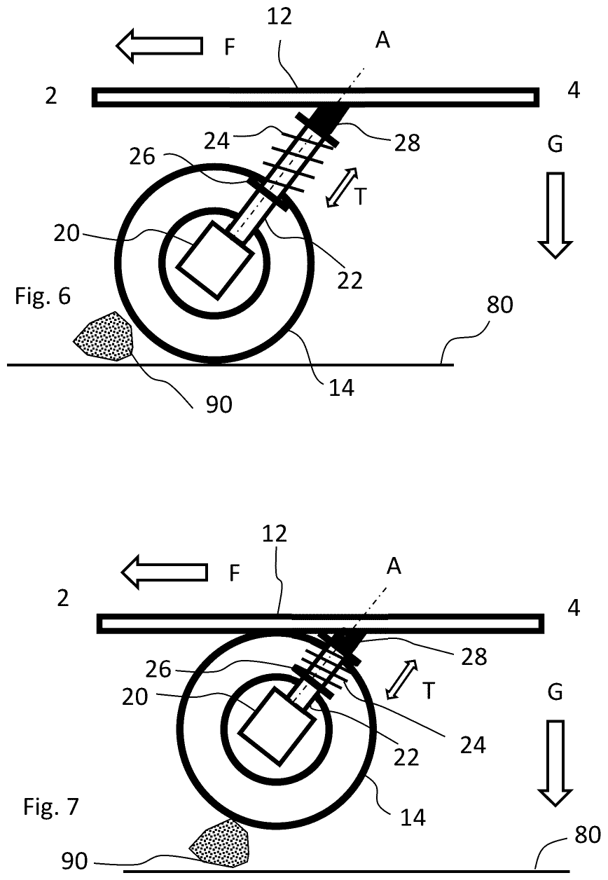

In the embodiment of FIGS. 2 to 5 and also in all the embodiments of the present invention shown in FIGS. 6 to 26 the spring element 24 may comprise any kind spring, such as a coil spring, leaf spring, balance spring, volute spring, arc spring, cantilever spring, V-spring, gas spring, ideal spring, or the like. The present invention is not limited to any particular type of springs.

FIGS. 6 and 7 show schematically one embodiment according to the present invention. In this embodiment the strut 22 is arranged to extend transversely in relation to the vertical direction G. Accordingly, the strut direction A is arranged to extend transversely to the vertical direction.

In this embodiment, the spring element 24 corresponds the spring element of the embodiment of the FIGS. 2 to 5.

The strut 22 and the spring element 24 together define the suspension direction T in which the wheel 14 moves in relation to the chassis 12 when the wheel 14 encounters the obstacle 90.

In FIG. 6 the suspension arrangement and the wheel 14 are shown in the initial suspension position on the flat horizontal surface 80. In the initial suspension position the wheel 14 is in the initial wheel position in relation to the chassis 12.

In FIG. 7 the suspension arrangement and the wheel 14 are shown in the final suspension position when the wheel 14 overrides the high obstacle 90. In the final suspension position the wheel 14 is in the final wheel position in relation to the chassis 12. In the final wheel position the spring element 24 is compressed and the wheel 14 is moved towards the chassis 12 along the wheel suspension trajectory in the suspension direction T. The wheel suspension trajectory extends between the wheel initial position and the wheel final position.

As shown in FIGS. 6 and 7, the suspension direction T defined by the strut 22 and the spring element 24 extends transversely to the vertical direction G. Accordingly, wheel suspension trajectory between the initial wheel position and the final position is arranged to extend transversely to the vertical direction G.

As shown in FIGS. 6 and 7, the suspension direction T and the wheel suspension trajectory are inclined towards the back end 4 of the electric vehicle 10 in relation to the vertical direction G.

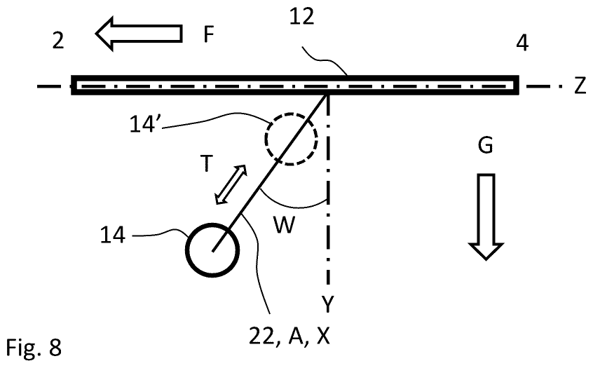

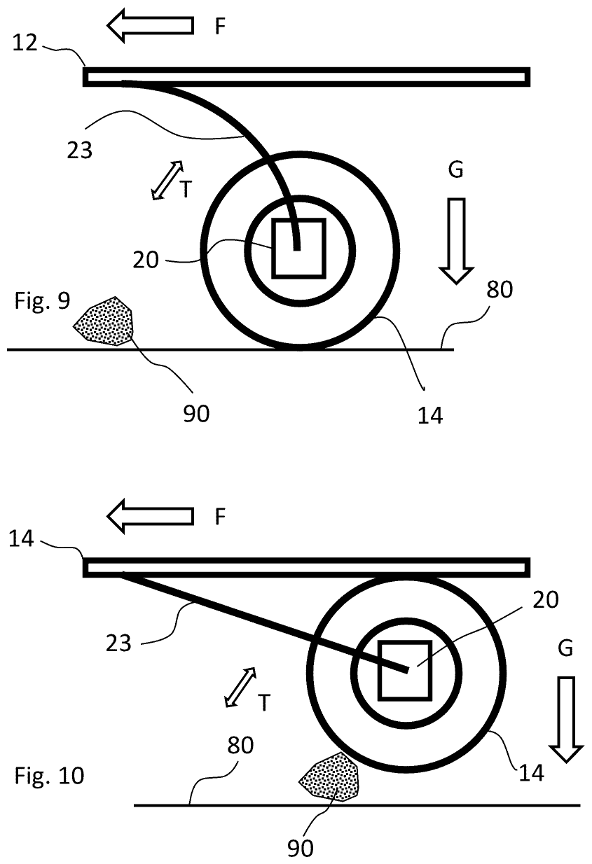

FIG. 8 shows a schematic view of the operation and structure of the embodiment of FIGS. 6 and 7.

The suspension arrangement comprises the strut 22 provided between the chassis 12 and the wheel 14. The wheel 14 is connected to the distal end of the strut 22. Proximal end of the strut 22 is connected to the chassis 12. The spring element 24 may be provided between the strut 22 and the chassis 12 or to the strut 22 between the proximal end and the distal end of the strut 22.

The wheel 14 is arranged to move in the suspension direction T between the initial wheel position and the final wheel position. The initial wheel position is shown with solid line and denoted with reference numeral 14. The final wheel position is shown with dotted line and denoted with reference numeral 14′. The wheel suspension trajectory X is configured to extend between the wheel initial position and the wheel final position.

The wheel suspension trajectory X is defined by the strut 22 and the spring element 24.

In the embodiment of FIGS. 6 to 8, the strut 22 is fixedly secured to the chassis 12 or in relation to the chassis 12. The strut 22 is provided as rigid strut 22. The strut 22 is further arranged to extend transversely to the vertical direction Y in the direction of the strut direction A.

The suspension direction T is arranged to extend in the direction of the strut 22 and the strut direction A.

In this embodiment, the wheel suspension trajectory X is arranged to extend along the strut direction A and parallel to the strut direction A. Accordingly, the wheel suspension trajectory X is arranged to extend transversely to the vertical direction Y.

In the embodiment of FIGS. 6 to 8, the wheel suspension trajectory X is arranged to extend along the strut 22 and in the strut direction A.

Accordingly, the wheel 14 is arranged to move with a suspension movement in the strut direction A and in the suspension direction T along the wheel suspension trajectory X.

The wheel suspension trajectory X is configured to have trajectory angle W in relation to the vertical direction Y, as shown in FIG. 8.

The trajectory angle W is arranged to be between 15 to 80 degrees, preferable between 20 to 70 degrees and more preferably between 25 to 60 degrees.

The strut 22, or the strut direction A, is also arranged to have a strut angle in relation to the vertical direction, the strut angle corresponding the trajectory angle W.

The wheel suspension trajectory X is arranged inclined relative to the vertical direction Y towards the back end 4 of the electric vehicle 10.

FIGS. 9 to 11 show another embodiment according to the present invention. In this embodiment the strut 23 is provided as a flexible strut 23 extending from the chassis 12.

FIGS. 9 and 10 show schematically one embodiment according to the present invention. In this embodiment the flexible strut 23 is arranged to extend from the chassis 12.

The flexible strut 23 is provided as an arch-shaped strut 23. The arch shaped strut 23 is configured to curve downwards and towards the surface 80 in the initial wheel position.

In the FIGS. 9 to 11 arch-shaped strut 23 is provided to be concave towards the surface 80.

In an alternative embodiment the arch-shaped flexible strut 23 is arranged to be convex towards the surface 80.

In a further alternative embodiment, the flexible strut 23 is provided as a straight flexible strut 23 in the initial wheel position.

The flexible strut 23 is further arranged to extend in the direction between the front end 2 and back end of the electric vehicle towards the back end 4.

The flexible strut 23 is arranged to bend when the wheel 14 encounters the obstacle 90.

The strut 23 and the spring element 24 together define the suspension direction T in which the wheel 14 moves in relation to the chassis 12 when the wheel 14 encounters the obstacle 90. Accordingly, the flexible strut 23 is configured to form the spring element of the suspension arrangement.

In FIG. 9 the suspension arrangement and the wheel 14 are shown in the initial suspension position on the flat horizontal surface 80. In the initial suspension position the wheel 14 is in the initial wheel position in relation to the chassis 12.

In FIG. 10 the suspension arrangement and the wheel 14 are shown in the final suspension position when the wheel 14 overrides the high obstacle 90. In the final suspension position the wheel 14 is in the final wheel position in relation to the chassis 12. In the final wheel position, the flexible strut 23 is bent and the wheel 14 is moved towards the chassis 12 along the wheel suspension trajectory in the suspension direction T due to the bending of the flexible strut 23. The wheel suspension trajectory extends between the wheel initial position and the wheel final position.

As shown in FIGS. 9 and 10, the suspension direction T defined by the flexible strut 23 and the bending of the flexible strut 23 extends transversely to the vertical direction G. Accordingly, wheel suspension trajectory between the initial wheel position and the final position is arranged to extend transversely to the vertical direction G.

As shown in FIGS. 9 and 10, the suspension direction T and the wheel suspension trajectory are inclined towards the back end 4 of the electric vehicle 10 in relation to the vertical direction G.

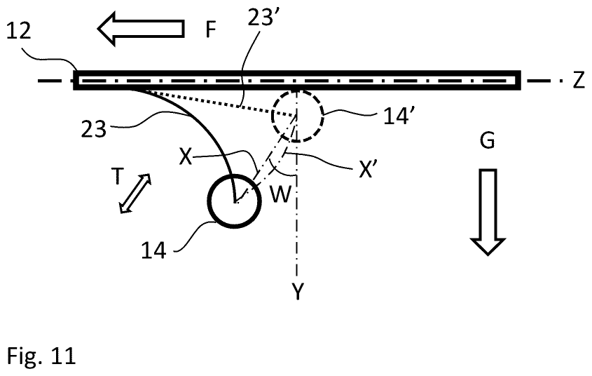

FIG. 11 shows a schematic view of the operation and structure of the embodiment of FIGS. 9 and 10.

The suspension arrangement comprises the flexible strut 23 provided between the chassis 12 and the wheel 14. The wheel 14 is connected to the distal end of the flexible strut 23. Proximal end of the strut 23 is connected to the chassis 12. The flexible strut 23 is arranged to bend between the proximal end and the distal end. Therefore, the flexible strut 23 is arranged to form the spring element.

The wheel 14 is arranged to move in the suspension direction T between the initial wheel position and the final wheel position. The initial wheel position is shown with solid line and denoted with reference numeral 14. The final wheel position is shown with dotted line and denoted with reference numeral 14′. The wheel suspension trajectory X is configured to extend between the wheel initial position and the wheel final position.

In the FIG. 11, a real wheel suspension trajectory is shown with dotted line denoted as X′. The real wheel suspension trajectory X′ is curved wheel suspension trajectory.

In the present invention, the defined wheel suspension trajectory X is defined as a straight line between the initial wheel position and the final wheel position, as denoted with dotted line X. In the description of the present invention, this defined wheel suspension trajectory X is used.

The wheel suspension trajectory X is defined by the flexible strut 23 and the bending of the flexible strut 23.

In the embodiment of FIGS. 9 to 11, the flexible strut 23 is fixedly secured to the chassis 12 or in relation to the chassis 12.

The flexible strut 23 is further arranged to extend transversely to the vertical direction Y in the direction of the strut direction A.

The suspension direction T in which the wheel moves in relation to the chassis is arranged to extend transversely to the vertical direction Y.

In this embodiment, the wheel suspension trajectory X is arranged to be defined by the flexible strut 23 and bending thereof.

The flexible strut 23 is arranged to bend elastically. The flexible strut 22 is provided as an elastic flexible strut 23.

The wheel suspension trajectory X is defined by the length and bending of the elastic strut 23.

In the embodiment of FIGS. 9 to 11, the wheel 14 is arranged to move with a suspension movement in the suspension direction T along the wheel suspension trajectory X.

The wheel suspension trajectory X is configured to have trajectory angle W in relation to the vertical direction Y, as shown in FIG. 11.

The trajectory angle W is arranged to be between 15 to 80 degrees, preferable between 20 to 70 degrees and more preferably between 25 to 60 degrees.

The wheel suspension trajectory X is arranged inclined relative to the vertical direction Y towards the back end 4 of the electric vehicle 10.

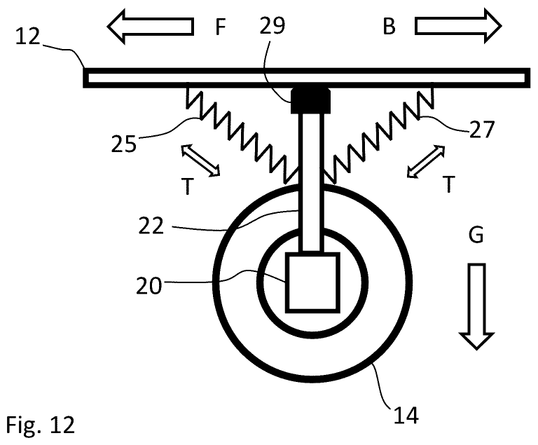

FIGS. 12 to 15 show a further embodiment of the present invention. In this embodiment, the strut 22 is pivotably connected to the chassis 12 with a pivot connection 29.

The pivot connection 29 comprises a pivot axis extending in horizontal direction.

The pivot axis of the pivot connection 29 is preferably arranged to extend perpendicularly to the direction extending between the front end 2 and back end 4 of the electric vehicle 10.

Accordingly, the strut 22 is arranged to turn around pivot axis of the pivot connection 29.

The strut 22 is arranged to turn around the pivot axle of the pivot connection 29 towards the back end 4 or towards the front end 2, or towards the back end 4 and the front 2 of the electric vehicle 10.

Th suspension arrangement comprises one or more spring elements 25, 27 arranged between the strut 22 and the chassis 12. Th spring elements 25, 27 are arranged to stretch and compress as a response to the turning of the strut 22 around the pivot axle of the pivot connection 29.

The embodiment of FIG. 12 comprises a front spring element 25 arranged to compress as response to turning of the strut 22 towards the front end 2.

The embodiment of FIG. 12 also comprises a back spring element 27 arranged to compress as response to turning of the strut 22 towards the back end 4.

The back spring element 27 is arranged to stretch as a response to turning of the strut 22 towards the front end 2.

The front spring element 25 is arranged to stretch as a response to turning of the strut 22 towards the back end 4.

In FIG. 12 the suspension arrangement and the wheel 14 are shown in the initial suspension position on the flat horizontal surface 80. In the initial suspension position the wheel 14 is in the initial wheel position in relation to the chassis 12.

In this initial wheel position, the strut 22 may be arranged to extend in the vertical direction G.

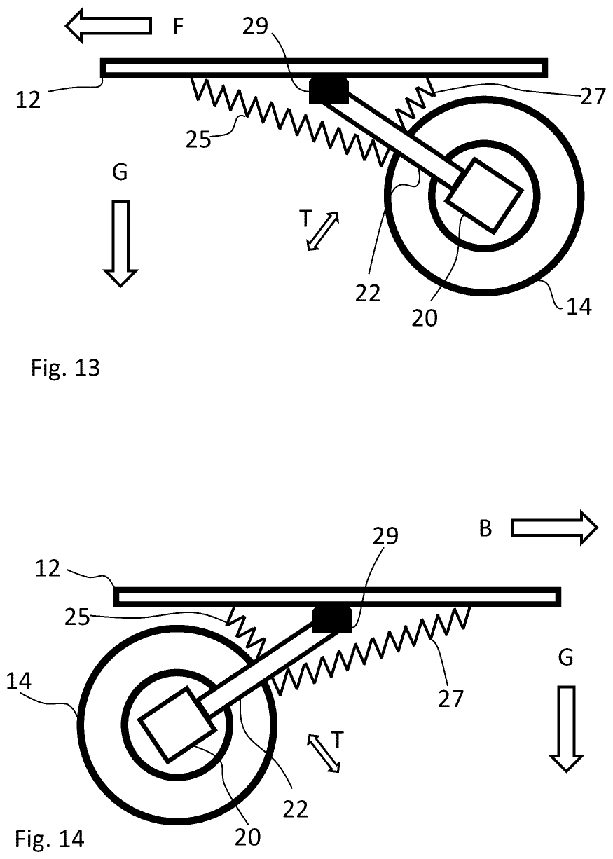

In FIG. 13 the suspension arrangement and the wheel 14 are shown in a first final suspension position when the wheel 14 overrides the high obstacle 90. In the first final suspension position the wheel 14 is in a first final wheel position in relation to the chassis 12. In the first final wheel position, the strut 22 is turned around the pivot axle of the pivot connection 29 and the wheel 14 is moved towards the chassis 12 along the wheel suspension trajectory in the suspension direction T due to the turning of the strut 22. The wheel suspension trajectory extends between the first wheel initial position and the wheel final position.

FIG. 13 shows a situation in when the electric vehicle 10 is moving in forward direction F. The strut 22 is arranged to turn around the pivot axle of the pivot connection 29 and towards the back end 4 when the wheel 14 overruns the obstacle 90.

In FIG. 14 the suspension arrangement and the wheel 14 are shown in a second final suspension position when the wheel 14 overrides the high obstacle 90. In the second final suspension position the wheel 14 is in a second final wheel position in relation to the chassis 12. In the second final wheel position, the strut 22 is turned around the pivot axle of the pivot connection 29 and the wheel 14 is moved towards the chassis 12 along the wheel suspension trajectory in the suspension direction T due to the turning of the strut 22. The wheel suspension trajectory extends between the wheel initial position and the second wheel final position.

FIG. 14 shows a situation in when the electric vehicle 10 is moving in backward direction B. The strut 22 is arranged to turn around the pivot axle of the pivot connection 29 and towards the front end 2 when the wheel 14 overruns the obstacle 90.

As shown in FIGS. 13 and 14, the suspension direction T defined by the strut 22 and the turning of the strut 22 extends transversely to the vertical direction G. Accordingly, wheel suspension trajectory between the initial wheel position and the final position, the first and second final positions, is arranged to extend transversely to the vertical direction G.

As shown in FIG. 13, the suspension direction T and the wheel suspension trajectory are inclined towards the back end 4 of the electric vehicle 10 in relation to the vertical direction G, as a response to movement of the electric vehicle in forward direction.

As shown in FIG. 14, the suspension direction T and the wheel suspension trajectory are inclined towards the front end 2 of the electric vehicle 10 in relation to the vertical direction G, as a response to movement of the electric vehicle in backward direction.

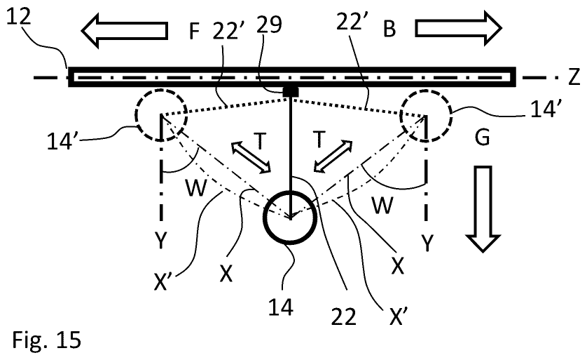

FIG. 15 shows a schematic view of the operation and structure of the embodiment of FIGS. 12 to 14.

The suspension arrangement comprises the strut 22 provided between the chassis 12 and the wheel 14. The wheel 14 is connected to the distal end of the strut 22. Proximal end of the strut 22 is pivotably connected to the chassis 12. The strut 22 is arranged to turn around the pivot axle of the pivot connection 29. The front and back spring elements 25, 27 are arranged between the strut 22 and the chassis 12 and arranged to stretch and compress as a response to the turning of the strut 22.

The wheel 14 is arranged to move in the suspension direction T between the initial wheel position and the final wheel position, or the first and second final wheel positions. The initial wheel position is shown with solid line and denoted with reference numeral 14. The final wheel positions, the first and second final wheel positions, are shown with dotted line and denoted with reference numeral 14′.

The wheel suspension trajectory X is configured to extend between the wheel initial position and the wheel final position.

In the FIG. 15, real wheel suspension trajectories are shown with dotted line denoted as X′. The real wheel suspension trajectory X′ is a curved wheel suspension trajectory.

In the present invention, the defined wheel suspension trajectory X is defined as a straight line between the initial wheel position and the final wheel position, or the first and second final wheel positions, as denoted with dotted line X. In the description of the present invention, this defined wheel suspension trajectory X is used.

The wheel suspension trajectory X is defined by the strut 22 and the turning of the strut 22.

In the embodiment of FIGS. 12 to 15, the strut 22 is pivotably secured to the chassis 12 or in relation to the chassis 12. The strut 22 is arranged to turn around the pivot axis of the pivot connection in relation to the vertical direction Y. The strut 22 is further provided as rigid strut 22.

The suspension direction T in which the wheel moves in relation to the chassis is arranged to extend transversely to the vertical direction Y.

In this embodiment, the wheel suspension trajectory X is arranged to be defined by the strut 22 and turning thereof.

The wheel suspension trajectory X is defined by the length and turning of the strut 22.

In the embodiment of FIGS. 12 to 15, the wheel 14 is arranged to move with the suspension movement in the suspension direction T along the wheel suspension trajectory X when the strut 22 in turned as response to the wheel overriding the obstacle 90.

The wheel suspension trajectory X is configured to have trajectory angle W in relation to the vertical direction Y, as shown in FIG. 15.

The trajectory angle W is arranged to be between 15 to 80 degrees, preferable between 20 to 70 degrees and more preferably between 25 to 60 degrees.

The wheel suspension trajectory X is arranged inclined relative to the vertical direction Y towards the back end 4 of the electric vehicle 10.

FIG. 15 shows schematically an electric vehicle 10 and the suspension arrangement according to the present invention. The suspension arrangement comprises at least three wheels 14 each of which is independently supported to the chassis 12.

Each of the wheels 14 is independently supported to the chassis 12 with a separate suspension support. The suspension support comprises the strut 22 and the at least one sprig element 24.

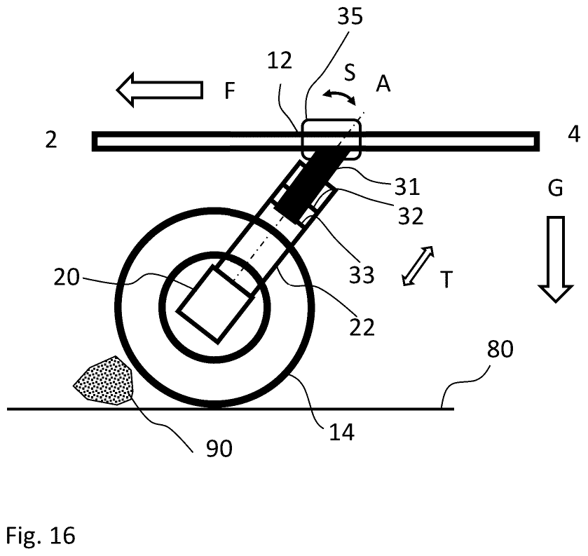

FIGS. 16 to 19 show schematically a further embodiment of the present invention. This suspension arrangement provides a lever suspension. In this embodiment the strut 22 is arranged to extend transversely in relation to the vertical direction G. Accordingly, the strut direction A is arranged to extend transversely to the vertical direction G.

In this embodiment, the chassis 12 is provided with chassis support 31. The suspension support comprises the strut 22 and two spring elements 32, 33 extending between the strut 22 and the chassis 12. The two spring elements 32, 33 are connected to the chassis support 31. Accordingly, the strut 22 is connected to the chassis support 31 with the two spring elements 32, 33.

It should be noted that the chassis support 31 may be omitted and the spring elements 32, 33 may be arranged between the strut 22 and the chassis 12.

Further it should be noted, that the suspension support may comprise one or more spring elements 32, 33 in this embodiment.

The spring elements 32, 33 are provided a leaf springs or the like spring elements.

The spring elements are arranged to extend in a direction transversal or perpendicular to the strut 22.

The strut 22 and the spring elements 32, 33 together define the suspension direction T in which the wheel 14 moves in relation to the chassis 12 and the chassis support 31 when the wheel 14 encounters the obstacle 90.

In this embodiment, the strut 22 is provided as a rigid strut 22.

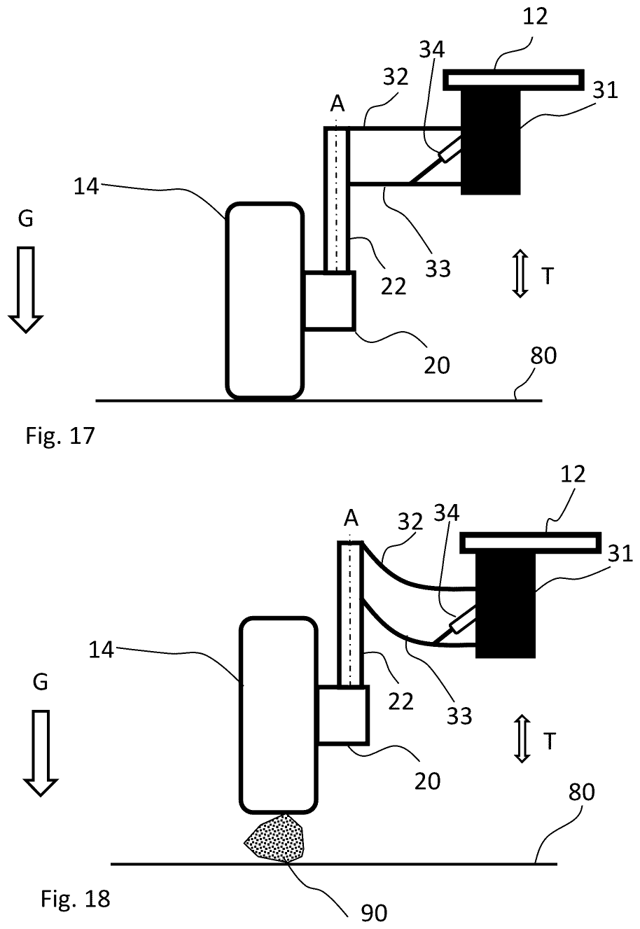

In FIG. 17 the suspension arrangement and the wheel 14 are shown in the initial suspension position on the flat horizontal surface 80. In the initial suspension position the wheel 14 is in the initial wheel position in relation to the chassis 12.

In FIG. 18 the suspension arrangement and the wheel 14 are shown in the final suspension position when the wheel 14 overrides the small or low obstacle 90. In the final suspension position the wheel 14 is in the final wheel position in relation to the chassis 12. In the final wheel position the spring elements 32, 33 are deformed and bent and the wheel 14 is moved towards the chassis 12 along the wheel suspension trajectory in the suspension direction T, as shown in FIG. 16. The wheel suspension trajectory extends between the wheel initial position and the wheel final position.

As shown in FIG. 16, the suspension direction T defined by the strut 22 and the spring elements 32, 33 extend transversely to the vertical direction G. Accordingly, wheel suspension trajectory between the initial wheel position and the final position is arranged to extend transversely to the vertical direction G.

As shown in FIG. 16, the suspension direction T and the wheel suspension trajectory are inclined towards the back end 4 of the electric vehicle 10 in relation to the vertical direction G.

The embodiment of FIGS. 16 to 19 the suspension support further comprises an additional suspension element 34 arranged between the spring elements 32, 33 and the chassis 12, or between the spring elements 32, 33 and the chassis support 31.

The additional suspension element 34 provides additional suspension and further increases the suspension distance which the wheel is able to move during the suspension movement.

In preferred embodiments, the additional suspension element 34 is arranged to have higher nominal suspension force or rigidity than the spring elements 32, 33.

In the embodiment of FIGS. 16 to 19, the additional suspension element 34 is a gas cylinder. However, in alternative embodiments, the additional suspension element 34 may also be provided as an additional spring element.

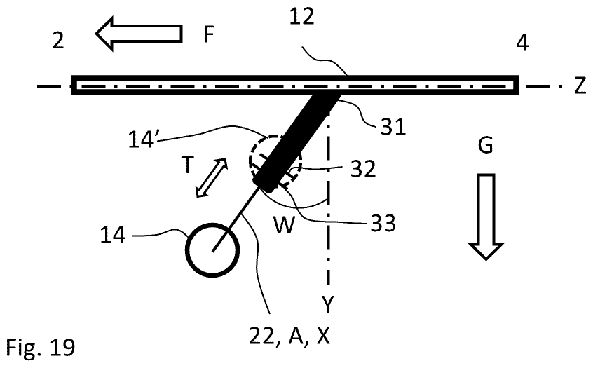

FIG. 19 shows a schematic view of the operation and structure of the embodiment of FIGS. 16 to 18.

The suspension arrangement comprises the strut 22 connected to the wheel 14. The wheel 14 is connected to the distal end of the strut 22. The strut 22 is connected opt the chassis 12 or to the chassis support 31 with the one or more spring element 32, 33. The wheel 14 is arranged to move in the suspension direction T between the initial wheel position and the final wheel position. The initial wheel position is shown with solid line and denoted with reference numeral 14. The final wheel position is shown with dotted line and denoted with reference numeral 14′. The wheel 14 is arranged to move in the suspension direction T in relation to the chassis when the one or more spring elements 32, 33 deform or bend.

The wheel suspension trajectory X is configured to extend between the wheel initial position and the wheel final position.

The wheel suspension trajectory X is defined by the strut 22 and the spring elements 32, 33.

In the embodiment of FIGS. 16 to 19, the strut 22 is connected to the chassis 12 via the spring elements 32, 33. The strut 22 is provided as rigid strut 22.

The strut 22 is further arranged to extend transversely to the vertical direction Y in the direction of the strut direction A.

The suspension direction T is arranged to extend in the direction of the strut 22 and the strut direction A.

In this embodiment, the wheel suspension trajectory X is arranged to extend along the strut direction A and parallel to the strut direction A. Accordingly, the wheel suspension trajectory X is arranged to extend transversely to the vertical direction Y.

In the embodiment of FIGS. 16 to 19, the wheel suspension trajectory X is arranged to extend along the strut 22 and in the strut direction A.

Accordingly, the wheel 14 is arranged to move with a suspension movement in the strut direction A and in the suspension direction T along the wheel suspension trajectory X.

The wheel suspension trajectory X is configured to have trajectory angle W in relation to the vertical direction Y, as shown in FIG. 19.

The trajectory angle W is arranged to be between 15 to 80 degrees, preferable between 20 to 70 degrees and more preferably between 25 to 60 degrees.

The strut 22, or the strut direction A, is also arranged to have a strut angle in relation to the vertical direction, the strut angle corresponding the trajectory angle W.

The wheel suspension trajectory X is arranged inclined relative to the vertical direction Y towards the back end 4 of the electric vehicle 10.

In the embodiment of FIGS. 16 to 19 the suspension arrangement further comprises a strut adjustment mechanism 35 arranged to adjust the strut direction of the strut 22. Accordingly, the strut adjustment mechanism 35 is arranged to set the strut 22 to extends in different strut directions in relation to the chassis 12 and in relation to the vertical direction G.

In some embodiments, the strut adjustment mechanism 35 enables setting the strut direction of the strut 22 to be between 15 to 80 degrees, preferable between 20 to 70 degrees and more preferably between 25 to 60 degrees in relation to the vertical direction G. The

[symbol]

It should be noted, that the strut adjustment mechanism 35 may be implemented in any of the embodiments of the present invention defined in FIGS. 6 to 25, or other embodiments within the scope of the present invention.

Changing the strut direction with the strut adjustment mechanism is shown with arrow S in FIG. 16.

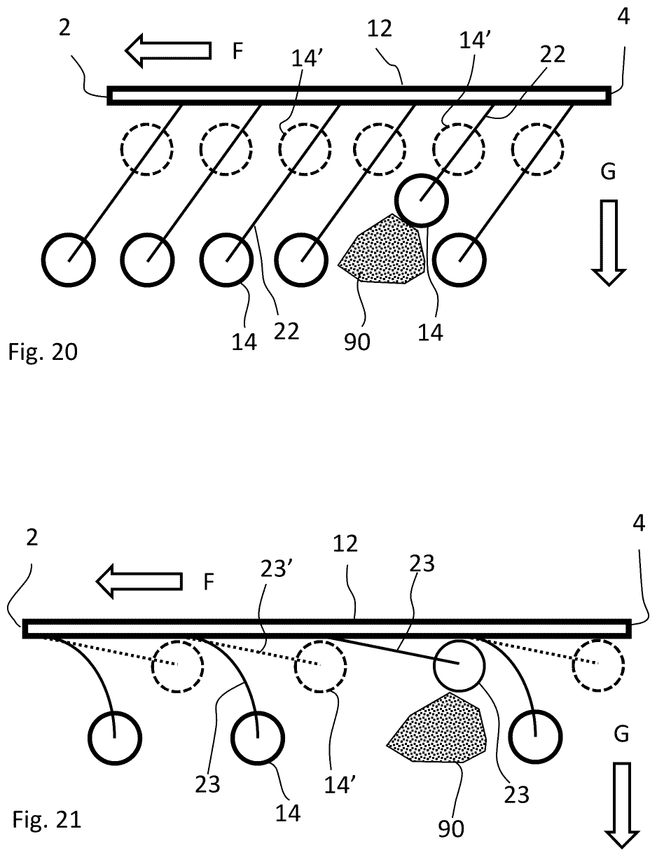

In the embodiment of FIG. 20, the suspension arrangement comprises the suspension support according to the embodiment of FIGS. 6 to 8 for each of the wheels 14.

In FIG. 20, the wheels 14 are shown with solid line in present position relative to the chassis 12. The final wheel position of the wheels 14 is shows with dotted line and denoted with 14′. As shown in FIG. 20, all the wheels 14 except the one overrunning the obstacle 90 are in the initial wheel position.

Accordingly, in the present invention each wheel 14 is suspended separately to the chassis 12 and independently of the other wheels 14.

The wheel suspension trajectory between the initial wheel position and the final wheel position is transverse to the vertical direction, according to the present invention.

In the embodiment of FIG. 21, the suspension arrangement comprises the suspension support according to the embodiment of FIGS. 9 to 11 for each of the wheels 14.

In FIG. 21, the wheels 14 are shown with solid line in present position relative to the chassis 12. The final wheel position of the wheels 14 is shows with dotted line and denoted with 14′. As shown in FIG. 21, all the wheels 14 except the one overrunning the obstacle 90 are in the initial wheel position.

Accordingly, in the present invention each wheel 14 is suspended separately to the chassis 12 and independently of the other wheels 14.

The wheel suspension trajectory between the initial wheel position and the final wheel position is transverse to the vertical direction, according to the present invention.

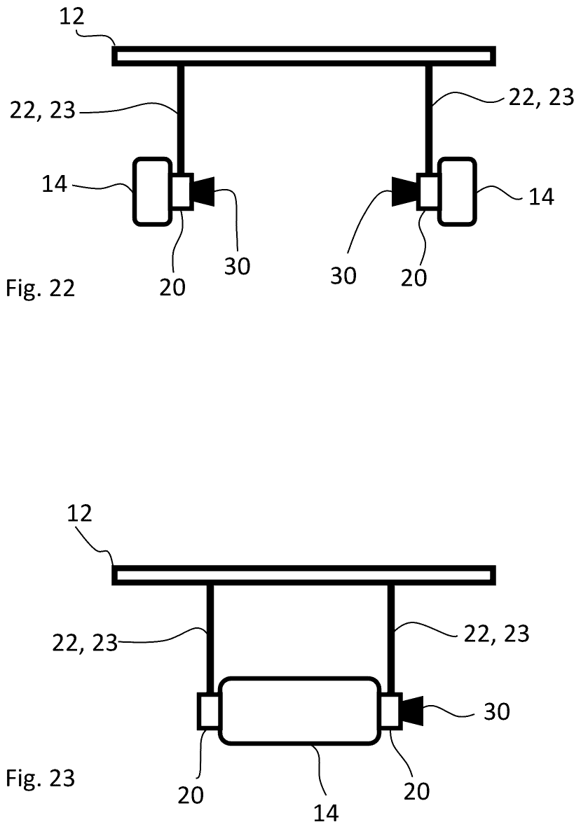

FIG. 22 shows one embodiment of the electric vehicle 10 of the present invention. The electric vehicle 10 comprises at least three wheels 14 each of which is independently supported to the chassis 12 with the suspension support comprising the strut 22, 23.

The at least three wheels 14 are arranged successively. The at least three wheels are arranged successively in a direction between the front end 2 and the rear end 4 of the chassis 12. Accordingly, the at least three wheels 14 are arranged successively in the moving direction F of the vehicle.

As shown in FIG. 22, at least three wheels 14 arranged successively in a first line and at least three wheels 14 arranged successively in a second line. The first line and the second line being arranged adjacent to each other.

Further, a separate electric motor 30 operatively connected to at least two of the wheels 14 for providing driving power. Preferably, a separate electric motor 30 operatively connected to each of the wheels 14 for providing driving power.

The electric motors 30 are preferably provided to the wheels 14 or in connection with wheels 14.

FIG. 23 shows one embodiment of the electric vehicle 10 of the present invention. The electric vehicle 10 comprises at least three wheels 14 each of which is independently supported to the chassis 12 with the suspension support comprising the strut 22, 23.

As shown in FIG. 23, at least three wheels 14 arranged successively in a line.

Further, a separate electric motor 30 operatively connected to at least one of the wheels 14 for providing driving power. Preferably, a separate electric motor 30 operatively connected to each of the wheels 14 for providing driving power.

The electric motors 30 are preferably provided to the wheels 14 or in connection with wheels 14.

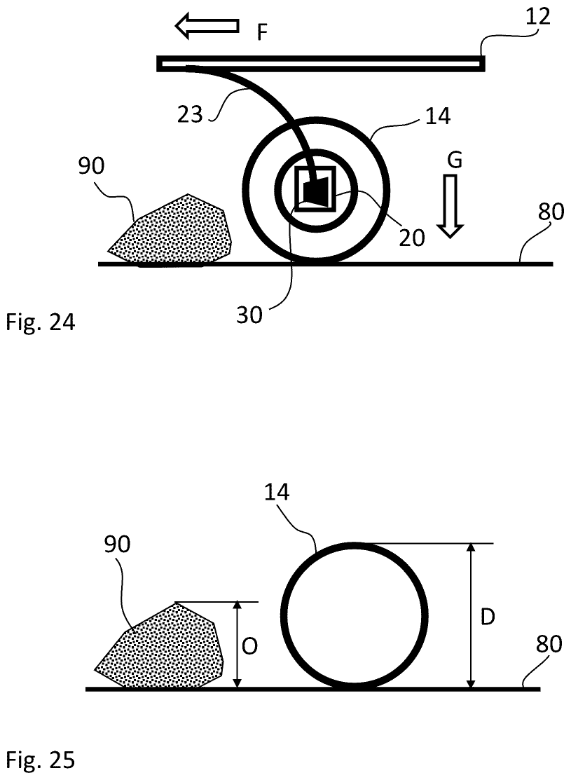

FIGS. 24 and 25 show schematically the advantage of the present invention. The present invention provides wheel suspension trajectory which is transverse to the vertical direction G. Each wheel 14 is independently supported to the chassis 12. Further, preferably each wheel 14 is provided with a separate electric motor 30. This enables each wheel 14 separately override the obstacle 90. Further, the height O of the obstacle 90 may be more than 50 percent of the diameter of the wheel 14. This allows utilizing small wheels 14.

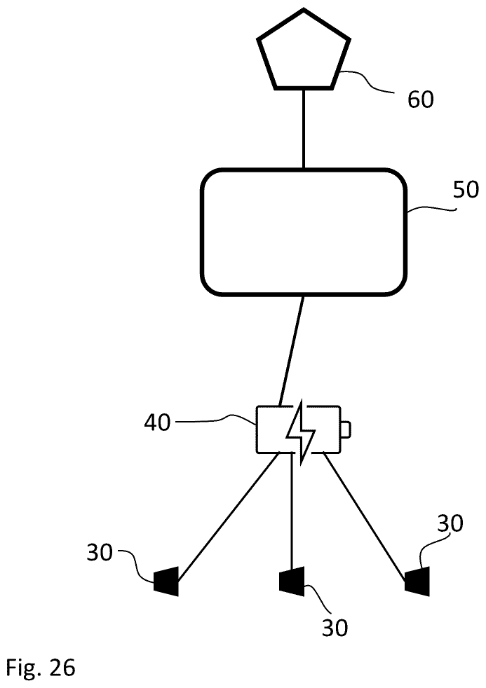

FIG. 26 further shows a driving system of the electric vehicle 10. The electric vehicle 10 comprises the electric motors 30 connected to a battery 40 and further to a central processing unit 50. Steering and operating equipment of electric vehicle are further connected to the central processing unit 50. The steering and operating commands or signals generated with the steering and operating equipment are transported to the central processing unit 50 which further generate driving signals or commends and transports them to the electric motors 30.

The invention has been described above with reference to the examples shown in the figures. However, the invention is in no way restricted to the above examples but may vary within the scope of the claims.

1. A vehicle suspension arrangement, comprising at least three wheels and each of the at least three wheels are independently supported to a chassis of a vehicle with a separate suspension support, the suspension support comprises a strut connected between the wheel and the chassis of the vehicle for supporting the wheel in a suspended manner to the chassis, and the suspension support being configured to define a wheel suspension trajectory along which the wheel is arranged to move in the suspended manner in relation to the chassis, the wheel suspension trajectory defined by the suspension support is configured to extend transversely to the vertical direction in a basic support position of the vehicle in which the vehicle is supported on a surface extending perpendicularly to the vertical direction, wherein
the vehicle suspension arrangement comprises at least three wheels arranged successively,
the at least three wheels are provided with electric motors, and
the wheel suspension trajectory defined by the suspension support is configured to have a trajectory angle between 15 to 80 degrees in relation to the vertical direction in the basic support position of the vehicle in which the vehicle is support on the surface extending perpendicularly to the vertical direction.

2. A vehicle suspension arrangement according to claim 1, wherein the trajectory angle is:
20 to 70 degrees in relation to the vertical direction, or
25 to 60 degrees in relation to the vertical direction.

3. A vehicle suspension arrangement according to claim 1, wherein the suspension support is configured to define a linear wheel suspension trajectory or a curved wheel suspension trajectory.

4. A vehicle suspension arrangement according to claim 1, wherein the suspension support is provided with one or more spring elements configured to enable suspension movement of the wheel in relation to the chassis in the suspended manner along the wheel suspension trajectory.

5. A vehicle suspension arrangement according to claim 4, wherein the strut is provided with the one or more spring elements the strut and the one or more spring elements are configured to define the wheel suspension trajectory together and to enable the suspension movement of the wheel in relation to the chassis in the suspended manner along the wheel suspension trajectory.

6. A vehicle suspension arrangement according to claim 5, wherein
the strut is arranged to extend in a strut direction from the chassis transversely to the vertical direction in the basic support position of the vehicle the wheel suspension trajectory is arranged extend in the strut direction and the one or more spring element are configured to enable the suspension movement of the wheel in the strut direction; or
the strut is arranged to extend in a strut direction from the chassis in a strut angle in relation to the vertical direction in the basic support position of the vehicle the one or more spring elements are configured to enable the suspension movement of the wheel in the strut direction, the trajectory angle of the wheel suspension trajectory corresponding the strut angle.

7. A vehicle suspension arrangement according to claim 4, wherein the one or more spring elements are arranged between the strut and the chassis of the vehicle the strut and the one or more spring elements are configured to define the wheel suspension trajectory together and to enable the suspension movement of the wheel in relation to the chassis in the suspended manner along the wheel suspension trajectory.

8. A vehicle suspension arrangement according to claim 7, wherein
the strut is pivotably connected to the chassis and arranged to extend from the chassis, the strut is arranged to move with a pivotable strut movement in relation to the chassis, the strut and the pivotable strut movement are configured to define the wheel suspension trajectory, the one or more spring elements are configured to apply spring force to strut during the pivotable strut movement of the strut the one or more spring elements are configured to enable the suspension movement of the wheel along the wheel suspension trajectory upon the pivotable strut movement of the strut; or
the strut is pivotably connected to the chassis and arranged to extend from the chassis, the strut is arranged to move with a pivotable strut movement around a horizonal strut pivot axis in relation to the chassis the strut and the pivotable strut movement are configured to define the wheel suspension trajectory, the one or more spring elements are configured to apply spring force to strut during the pivotable strut movement of the strut, the one or more spring elements are configured to enable the suspension movement of the wheel along the wheel suspension trajectory upon the pivotable strut movement of the strut around the horizontal strut pivot axis.

9. A vehicle suspension arrangement according to claim 4, wherein the strut is provided as a flexible strut, the flexible strut is configured to form the one or more spring elements and to bend in a strut bending direction transverse to the vertical direction in the basic support position of the vehicle the flexible strut and the strut bending direction are configured to define the wheel suspension trajectory and to enable the suspension movement of the wheel in relation to the chassis in the suspended manner along the wheel suspension trajectory.

10. A vehicle suspension arrangement according to claim 9, wherein
the flexible strut is provided as a longitudinal arch-shaped strut and arranged to extend from the chassis of the vehicle; or
the flexible strut is provided as a longitudinal linear strut and arranged to extend from the chassis of the vehicle.

11. A vehicle suspension arrangement according to claim 6, wherein the suspension arrangement comprises a strut adjustment mechanism arranged to adjust the strut direction of the strut, in which strut direction the strut is arranged to extend from the chassis transversely to the vertical direction in the basic support position of the vehicle.

12. A vehicle suspension arrangement according to claim 4, wherein the suspension support further comprises an additional suspension element arranged between the one or more spring elements and the chassis.

13. A vehicle suspension arrangement according to claim 1, wherein the vehicle suspension arrangement comprises at least three wheels arranged successively in a first line and at least three wheels arranged successively in a second line, the first line and the second line being arranged adjacent to each other.

14. An electric vehicle comprising:
a chassis
a suspension arrangement, comprising:
at least three wheels, and
a separate suspension support for each of the at least three wheels each of the wheels being independently supported to the chassis of the electric vehicle with the suspension support in a suspended manner, the suspension support being configured to define a wheel suspension trajectory along which the wheel is arranged to move in the suspended manner in relation to the chassis; and
an electric motor operatively connected to at least one of the three wheels, wherein
the wheel suspension trajectory defined by suspension support is configured to extend transversely to the vertical direction in a basic support position of the vehicle in which the vehicle is supported on a surface extending perpendicularly to the vertical direction,
the suspension arrangement comprises at least three wheels arranged successively,
a separate electric motor operatively connected to each of the at least three wheels (14) for providing driving power, and
the wheel suspension trajectory defined by the suspension support is configured to have a trajectory angle between 15 to 80 degrees in relation to the vertical direction in the basic support position of the vehicle in which the vehicle is support on the surface extending perpendicularly to the vertical direction.

15. An electric vehicle according to claim 14, wherein the trajectory angle is between 20 to 70 degrees and preferably 25 to 60 degrees in relation to the vertical direction.

16. An electric vehicle according to claim 14, wherein
the suspension support is arranged to define the wheel suspension trajectory such that wheel suspension trajectory is configured to be inclined in relation to the vertical direction according to the trajectory angle in a direction opposite to the moving direction of the electric vehicle; or
the electric vehicle (10) comprises a front end and a back end, the suspension support is arranged to define the wheel suspension trajectory such that wheel suspension trajectory is configured to be inclined in relation to the vertical direction according to the trajectory angle in a direction towards the back end of the electric vehicle; or
the electric vehicle comprises a front end and a back end, the suspension support is arranged to define the wheel suspension trajectory such that wheel suspension trajectory is configured to be inclined in relation to the vertical direction according to the trajectory angle in a direction towards the back end of the electric vehicle upon forward movement of the electric vehicle and the suspension support is arranged to define the wheel suspension trajectory such that wheel suspension trajectory is configured to be inclined in relation to the vertical direction according to the trajectory angle in a direction towards the front end of the electric vehicle upon backward movement of the electric vehicle.

17. An electric vehicle according to claim 14, wherein the suspension arrangement comprises at least three wheels arranged successively in a first line and at least three wheels arranged successively in a second line, the first line and the second line being arranged adjacent to each other.

18. An electric vehicle according to claim 14, wherein the electric motors are provided to the at least three wheels.

19. An electric vehicle comprising the vehicle suspension arrangement according to claim 1.
